(19) United States
(12) Patent Application Publication
(10) Pub. No.: US 2017/0333951 A1
(43) Pub. Date: Nov. 23, 2017

(54) Operating controls for a vertical separator

(71) Applicants: Kenneth Abbott, Tucson, AZ (US); Mark Ellery Ogram, Tucson, AZ (US)

(72) Inventors: Kenneth Abbott, Tucson, AZ (US); Mark Ellery Ogram, Tucson, AZ (US)

(73) Assignee: Lost Dutchman Mines LLC., Tucson, AZ (US)

(21) Appl. No.: 14/999,514

(22) Filed: May 18, 2016

(51) Int. Cl. B07B 11/04; B07B 7/01

(52) U.S. Cl. CPC B07B 11/04; B07B 7/01

(57) ABSTRACT

A vertical separator system with an enhanced control mechanism which employs one or more micro-adjustment features. The micro-adjustment features include a combination of an air bladder, a mass sensor, and/or a bleed valve.

### BACKGROUND OF THE INVENTION

This invention relates generally to vertical separators and more specifically to the control system therefor.

Vertical separators are well known in the art. They include, but are not limited to those described in U.S. Pat. No. 5,103,981, entitled “Particle Separator/Classification Mechanism” issued to Abbott et al. on Apr. 14, 1992; and U.S. Pat. No. 9,073,087, entitled “Injector Mechanism” issued to Abbott on Jul. 7, 2015; both of which are incorporated hereinto by reference.

In these mechanisms, a controlled airflow is created in a vertical tube by a fan or similar mechanism. The material which is to be separated is deposited into this airflow which lifts the lighter particles and permits the heavier particles to precipitate. Key to this process, especially when the specific gravity between the particles is only slight, is the creation of a precise and controlled airflow.

Typically, this control of the airflow is via control of the fan speed which is drawing the air through the vertical tube. Because of the very nature of the fan's electrical properties, significant fluctuations in the airflow are common. This has adverse effects on the operation of the mechanism.

It is clear there is a need more dynamic control systems for vertical separators.

### SUMMARY OF THE INVENTION

The invention is a vertical separator system with an enhanced control mechanism which employs one or more micro-adjustment features. The micro-adjustment features include a combination of an air bladder, a mass sensor, and/or a bleed valve.

In one embodiment of the invention, the vertical separator tube has the initial airflow established by the controller via the fan mechanism. The vertical separator tube has an upper section, a middle section, and a lower section. The feed mechanism deposits the material into the middle section of the vertical separator tube.

In this embodiment, using an airflow sensor, positioned at the lower section of the vertical separator tube, together with an adjustable air bladder positioned within the vertical separator tube, the control mechanism adjusts the adjustable air bladder to restrict/open the inside of the vertical separator tube to obtain a desired airflow within the vertical separator tube.

In preferred application of this embodiment, the adjustable air bladder is positioned substantially in the middle section and upper section of the vertical separator tube. This causes the lower section to have a lower airflow which encourages the precipitation of the heavier particles which have fallen past the air bladder.

In this application, the air bladder is inflated/deflated through the use of a compressed air source which is fed into, or bled off of, the bladder using a remotely controlled valve or pump, activated by the control mechanism.

Bladders are well known in the art and include, but are not limited to those described in: U.S. Pat. No. 9,126,515, entitled “Multi-contour Bladder System” issued to Diop et al. on Sep. 8, 2015; U.S. Pat. No. 9,198,477, entitled “Method for Manufacturing Inflatable Bladders for Use in Footwear and Other Articles of Manufacture” issued to Davis et al. on Dec. 2, 2015; and, U.S. Pat. No. 9,222,4562, entitled “Automobile Fuel System Pressurization Apparatuses and Method ” issued to Shore on Dec. 29, 2015; all of which are incorporated hereinto by reference.

In another embodiment of the invention, a mass sensor is positioned at the upper section of the vertical separator tube to identify when the vertical separator tube is becoming overly fed and “clogged” with lighter material. When this is sensed, the feed mechanism is adjusted appropriately.

In this context, the desired mass within the upper tube is chosen to be within a range as established from values within a memory unit.

Sensors which calibrate mass are well known in the art and include, but are not limited to those described in: U.S. Pat. No. 6,999,882, entitled “Method for Determining s Mass Airflow” issued to Frie, et al. on Feb. 14, 2006; U.S. Pat. No. 7,757,548, entitled “Calibrated Air Intake Tract having Air Infusion Insert” issued to Delgado on Jul. 20, 2010; U.S. Pat. No. 8,549,901, entitled “Sensor Structure” issued to Saito et al. on Oct. 8, 2013; U.S. Pat. No. 9,175,623, entitled “Mass Airflow Sensor Calibration Evaluation” issued to Kwok et al. on Nov. 3, 2015; and, U.S. Pat. No. 9,297,325, entitled “Systems and Methods for Compensating Airflow Determinations for Air Compressor Bleed” issued to Sujan et al. on Mar. 29, 2016; all of which are incorporated hereinto by reference.

In a further control, a remotely controlled bleed valve is placed in the upper section of the vertical separator tube. Through selected opening and closing of the valve, the airflow is minutely controlled as determined by the airflow sensor.

Remotely controlled values are well known in the art and include, but are not limited to those described in: U.S. Pat. No. 7,900,650, entitled “In-Line Water Shut-Off System and Method of Use Thereof” issued to Wilson on Mar. 8, 2011; U.S. Pat. No. 9,079,748, entitled “Remote Control for Valve and Hose Reel System” issued to Tracey et al. on Jul. 14, 2015; and, U.S. Pat. No. 9,309,645, entitled “Drive Control Method of Operating Machine” issued to Yamamoto, et al. on Apr. 12, 1016; all of which are incorporated hereinto by reference.

While the discussion above refers to the individual controls, the invention is not intended to be limited to the use of one of these controls, rather, the preferred embodiment uses all three and the use of any two is also contemplated.

The invention together with various embodiments will be more fully explained by the accompanying drawings and the following descriptions thereof.

### DRAWINGS IN BRIEF

FIG. 1 diagrams the use of all three sensors on a single unit although the invention is not so limited and may include any combination of the three sensors and control.

### DRAWINGS IN DETAIL

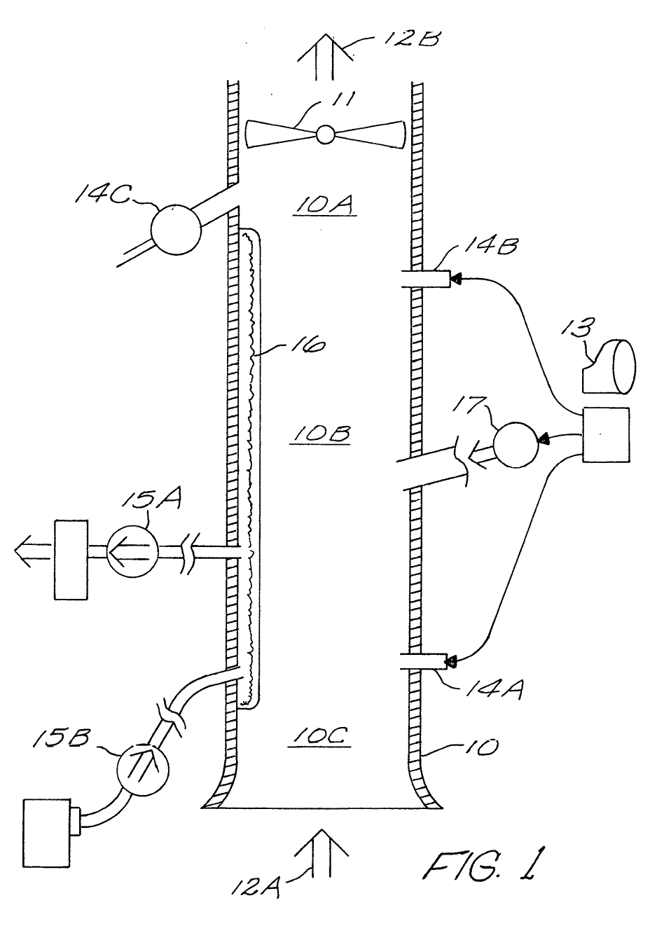

FIG. 1 diagrams the preferred embodiment in which all three sensors on a single unit. Note, the invention is not so limited. Other embodiments utilize any combination of the three sensors and control.

The invention is a vertical separator system of vertical separator tube 10 utilizing fan 11 to create an airflow 12A/12B through the vertical separator tube 10. The present invention utilizes an enhanced control mechanism 13. Micro-adjustment features for the various embodiments include any combination of an air bladder 16, a mass sensor 14B, a bleed valve 14C, and/or an airflow speed sensor 14A.

The vertical separator tube 10 consisting of an upper section 10A, a middle section 10B, and a lower section 10C. Fan 11 is proximate to the upper section 10A and selectively creates an airflow (illustrated by arrows 12A and 12B) within the vertical separator tube 10 from an open end at the lower section 10C.

Feed mechanism 17 deposits material into the middle section 10B of the vertical separator tube 10. An airflow sensor 14A is positioned at the lower section 10C of the vertical separator tube 10 and monitors the airflow 12A/12B. Control mechanism 13 receives signals from airflow sensor 14A and control mechanism 13 is able to control the speed of fan 11 to adjust the airflow (12A and 12B) in a “gross” manner.

Adjustable air bladder 16 is positioned within the vertical separator tube 10. Once control mechanism 13 establishes an initial speed for the fan 11, and, based upon data from the airflow sensor 14A, control mechanism 13 directs the inflation or deflation of air bladder 16 using air source 15B or pump 15A. This minute adjustment of air bladder 16 increases or decreases the cross sectional area of the center section 10B so that the desired airflow within the vertical separator tube 10 is obtained.

Air bladder 16 is inflated using compressed air 15B; air bladder 16 is evacuated using pump or vent valve 15A. Both the compressed air 15B and pump/vent valve 15A are controlled by control mechanism 13 to obtain the desired airflow as measured by sensor 14A.

In this embodiment, a mass sensor 14B is positioned at the upper section 10A of the vertical separator tube 10. Mass sensor 14B determines the mass of material being drawn up tube 10. If the mass sensor 14B indicates that the mass at the upper section 10A has become too high (indicating that the feed rate is too high or if there is too much gangue in it) then control mechanism 13 slows down the feed of material through feed mechanism 17.

In like fashion, if mass sensor 148 indicates that the mass of material in the upper section is “low” (indicating that the feed is too high or if the feed material has little gangue), then feed mechanism 17 is adjusted by control mechanism 13 to increase the feed rate.

In this manner, the feed rate is optimized to meet the capability of the mechanism.

Ideally, the mass is maintained within a range as established within a memory accessed by the control mechanism 13.

Another mechanism used by the present invention to minutely control airflow 12A/12B is through the use of a bleed valve 14C. Using data from the airflow sensor 14A, the bleed valve is selectively opened to allow ambient air into the upper section 10A of the vertical separator tube 10; conversely, the overall airflow 12a/12B is accelerated when bleed valve 14C is constricted by the control mechanism 13.

Bleed valve 14C provides a mechanism for adjusting the airflow 12A/12B in a minute fashion once the fan 11 has reached its operating state.

It is clear that the -present invention provides a need more dynamic control system for vertical separators.

What is claimed is:

1. A vertical separator system comprising:
a) a vertical separator mechanism having a vertical separator tube consisting of an upper section, a middle section, and a lower section, and a fan proximate to the upper section for selectively creating an airflow within the vertical separator tube through an open end at the lower section;
b) a feed mechanism for depositing material into the middle section of the vertical separator tube;
c) an airflow sensor positioned at the lower section of the vertical separator tube;
d) an adjustable air bladder positioned within the vertical separator tube; and,
e) a control mechanism which,
1) establishes an initial speed for the fan; and,
2) based upon data from the airflow sensor, adjusts the adjustable air bladder to obtain a desired airflow within the vertical separator tube.

2. The vertical separator system according to claim 1, wherein the adjustable air bladder is positioned substantially in the middle section and upper section of the vertical separator tube.

3. The vertical separator system according to claim 2, further including,
a) a source of compressed air; and,
b) a remotely controlled valve being activated by the control mechanism for selective communication of compressed air from the source of compressed air to the air bladder.

4. The vertical separator system according to claim 1:
a) further including a mass sensor positioned at the upper section of the vertical separator tube; and wherein
b) the feed mechanism is selectively adjustable; and,
c) the control mechanism adjusts the feed mechanism based upon data from the mass sensor to obtain a selected mass value within the upper section of the vertical separator tube.

5. The vertical separator system according to claim 4, wherein the selected mass is within a range of values established in a memory unit.

6. The vertical separator system according to claim 4,
a) further including a remotely controlled bleed valve selectively communicating ambient air into the upper section of the vertical separator tube; and,
b) wherein the control mechanism adjusts the remotely controlled bleed valve based upon data from the airflow sensor.

7. A vertical separator system comprising:
a) a vertical separator mechanism having, a vertical separator tube consisting of an upper section, a middle section, and a lower section, and a fan proximate to the upper section for selectively creating an airflow within the separator tube through an open end at the lower section;
b) a selectively adjustable feed mechanism for depositing material into the middle section of the vertical separator tube;
c) a mass sensor positioned at the upper section of the vertical separator tube; and,
1) a control mechanism which, based upon data from the mass sensor, selectively adjusts the feed mechanism to obtain a selected mass value within the upper section of the vertical separator tube.

8. The vertical separator system according to claim 7, wherein the selected mass is established within a range of values from a memory unit.

9. The vertical separator system according to claim 7,
a) further including an adjustable air bladder positioned within the vertical separator tube;
b) further including an airflow sensor position at the lower section of the vertical separator tube; and,
c) wherein the control mechanism selectively adjusts air pressure within the adjustable air bladder based upon data from the airflow sensor.

10. The vertical separator system according to claim 9:
a) further including a remotely controlled bleed valve selectively communicating ambient air into the upper section of the vertical separator tube; and,
b) wherein the control mechanism selectively adjusts the remotely controlled bleed valve based upon data from the airflow sensor.

11. A vertical separator system comprising:
a) a vertical separator mechanism having, a vertical separator tube consisting of an upper section, a middle section, and a lower section, and a fan proximate to the upper section for selectively creating an airflow within the separator tube through an open end at the lower section;
b) a feed mechanism for depositing material into the middle section of the vertical separator tube;
c) a remotely controlled bleed valve selectively communicating ambient air into the upper section of the vertical separator tube;
d) an airflow sensor positioned at the lower section of the vertical separator; and,
e) a control mechanism which,
1) establishes an initial speed for the fan, and,
2) based upon data from the airflow sensor, selectively adjusts the remotely controlled bleed valve.

12. The vertical separator system according to claim 11,
a) further including an adjustable air bladder positioned within the vertical separator tube; and,
b) wherein the control mechanism, selectively adjusts the adjustable air bladder based upon data from the airflow.

13. The vertical separator system according to claim 11,
a) further including a mass sensor positioned at the upper section of the vertical separator tube; and,
b) wherein the control mechanism selectively adjusts the feed mechanism based upon data from the mass sensor to obtain a desired mass within the upper section of the vertical separator tube.
